(19) United States
(12) Patent Application Publication
(10) Pub. No.: US 2003/0231209 A1
(43) Pub. Date: Dec. 18, 2003

(54) Data processing system

(76) Inventors: Frank Kappe, Graz (AT); Vedran Sabol, Graz (AT); Wolfgang Kienreich, Graz (AT)

Correspondence Address: OSTROLENK FABER GERB & SOFFEN, 1180 AVENUE OF THE AMERICAS, NEW YORK, NY, 100368403

(21) Appl. No.: 10/408,299

(22) Filed: Apr. 4, 2003

Related U.S. Application Data
(60) Provisional application No. 60/376,474, filed on Apr. 29, 2002.

(30) Foreign Application Priority Data
Apr. 5, 2002 (EP) 02 007 742.6

(51) Int. Cl. G09G 5/00

(52) U.S. Cl. 345/765; 345/418; 345/700

(57) ABSTRACT

A data processing system comprising means for determining a similarity between subcollections, means for determining first coordinates to the subcollections in accordance with the similarity and means for locating areas to the subcollections and a collection comprising these subcollections. There are further provided means for positioning the areas of the first and second subcollections within the area of the collection in accordance with the coordinates of the first and second subcollections, means for calculating a further similarity between first and second information elements and means for positioning the first and second information elements within the area of the respective subcollection comprising the first and second information element.

### CROSS-REFERENCE TO RELATED APPLICATIONS

This application is based upon and claims priority to European Patent Application No. 02 007 742.6, filed in the European Patent Office Apr. 5, 2002, and U.S. Provisional Patent Application No. 60/376,474, filed Apr. 29, 2002, the contents of both of which are incorporated herein by reference.

### FIELD OF THE INVENTION

The present invention relates to data processing systems, and in particular, to a method for displaying information, a data processing system for displaying information, a computer program stored on a computer usable medium, and to a computer program directly loadable into an internal memory of a digital computer.

### BACKGROUND OF THE INVENTION

A data processing system may be an individual computer comprising a processor, an internal memory, a storage, a display and an operating system to interconnect these elements such that they are interacting with each other. A data processing system may also be a communications network through which a number of computers may interconnect and communicate. The largest and best known computer communications network today is the Internet, a computer communications network based on worldwide data and telephone networks. The Internet is a network of networks, all available for the exchange of information. A combination of the Internet with interconnecting computers results in a web, the best known one is commonly referred to today as the worldwide web (“WEB”). The Internet interconnects every computer on the Internet with every other computer on the Internet. The computers connected to a network have various functions and purposes. Some of the interconnected computers are functioning as part of the network itself, i.e., controlling the routing and passage of data to and from various network nodes. Other interconnecting computers have files of information that are accessible by other computers connected to the network. Other computers are connected to the network by a user to obtain such files of information.

In large networks, such as the WEB, the amount of information available is substantial because of the number of sites on the WEB that provide information. In recent years, the amount of information available over the WEB has grown exponentially and will probably continue to do so for the foreseeable future. The challenge is how to find a specific item of information hidden in the enormous amount of information available. Thus, the interactive visualization of very large, hierarchically structured document collections or information collections, as well as a visualization of results of retrieval operations executed on such collections, has recently received much attention. With the ever-increasing number of documents and/or kinds of information stored on the WEB, or, alternatively, within corporate intranets, flat repositories containing the documents and/or information are increasingly and inevitably replaced by hierarchical structures for organizing documents and/or information into collections. As used herein, “flat repositories” typically comprise single-file applications that include a single, large address space. A “hierarchical structure” typically includes a plurality of data sources that link records together.

There are two basic approaches focusing on the interactive visualization of very large document collections available.

The first approach focuses on inter-documents similarity. However, this approach is only applicable for flat, unstructured repositories. A document corpus is represented by using maps or landscapes and a similarity of documents is shown by a proximity of these documents in these maps or landscapes. However, as already mentioned, this first basic approach is only applicable for flat repositories and unable for handling hierarchies.

The second basic approach focuses on navigation in hierarchically organized repositories such as documents classified according to a library classification scheme. Hierarchical structures may also be inferred from more heavily interlinked structures such as the WEB or computer networks.

U.S. Pat. No. 5,619,632 describes a two-dimensional tree browser which utilizes hyperbolic geometry to display an entire hierarchy on a two-dimensional display. The tree is laid out by using hyperbolic axes (which are infinite) and are then mapped to a two-dimensional unitary disk for display. Areas in a center of the disk are in focus and are clearly visible. However, areas in the proximity of the margin of the disk become infinitely small and are no longer discernible.

US 2001/0035885 A1 describes a graphical gateway to a computer network providing a text representation on any WEB or network directory on a two-dimensional surface. Various distinct categories included within the network directory are spread across the two-dimensional surface used as display screen and circled by polygon-shaped borders. The result is a “state” map created from a directory tree that has been mapped. A similarity or dissimilarity with respect to the content of two sites is expressed by a distance between these two sites.

All of the approaches presented above, are insufficient with respect to a representation of visualization of very large (up to millions of entities of information or documents) hierarchically structured information repositories.

### SUMMARY OF THE INVENTION

It is an object of the present invention to provide a method and means for the easy handling of very large hierarchically structured information repositories.

This object is solved with a method for displaying information comprising a plurality of information elements on a display, the information being organized in a collection comprising a first subcollection and a second subcollection, the first subcollection comprising a first number of information elements of the plurality of information elements and the second subcollection comprising a second number of information elements of the plurality of information elements, the method comprising: (a) determining a first similarity between the first subcollection and the second subcollection; (b) determining first coordinates for the first subcollection and the second subcollection in accordance with the first similarity; (c) allocating a first area having first boundaries to the collection such that a first size of the first area is related to a number of information elements of the information; (d) allocating a second area having second boundaries to the first subcollection such that a second size of the second area is related to the first number; (e) allocating a third area to the second subcollection such that a third size of the third area is related to the second number; (f) positioning the second and third areas within the first boundaries of the first area in accordance with the first coordinates; (g) determining a second similarity between a first information element of the first number of information elements and a second information element of the first number of information elements; and (h) positioning the first information element and the second information element within the second boundaries in accordance with the second similarity.

Preferably the first number of information elements is related to the total number of information elements comprised in a first subcollection, comprised in any collection comprised in the first subcollection and/or is comprised in any further subcollection comprised in the first subcollection. So is the second number of information elements.

Advantageously, this method allows one to explore very large hierarchically structured repositories containing information elements. The hierarchical organization of the information and inter-information similarity is represented within a single, consistent visualization. Furthermore, according to the method of claim 1, a global and a local view of the information elements on the two-dimensional display is integrated into one seamless visualization.

Furthermore, the above object is solved by a data processing system for displaying information, comprising a display, and an operating system, wherein the information comprises a plurality of information elements, wherein the information is organized in a collection comprising a first subcollection and a second subcollection, the first subcollection comprising a first number of information elements of the plurality of information elements and the second subcollection comprising a second number of information elements of the plurality of information elements, the data processing system comprising: (a) means for determining a first similarity between the first subcollection and the second subcollection; (b) means for determining first coordinates for the first subcollection and the second subcollection in accordance with the first similarity; (c) means for allocating a first area having first boundaries to the collection such that a first size of the first area is related to a number of information elements of the information; (d) means for allocating a second area having second boundaries to the first subcollection such that a second size of the second area is related to the first number; (e) means for allocating a third area to the second subcollection such that a third size of the third area is related to the second number; (f) means for positioning the second and third areas within the first boundaries of the first area in accordance with the first coordinates; (g) means for determining a second similarity between a first information element of the first number of information elements and a second information element of the first number of information elements; and (h) means for positioning the first information element and the second information element within the second boundaries in accordance with the second similarity.

Advantageously, the data processing system according to the present invention is very stable.

The above object is also solved by a computer program product stored on a computer usable medium, comprising: (a) computer readable program means for causing a computer to display information on a display, the information being organized in a collection comprising a first subcollection and a second subcollection, the first subcollection comprising a first number of information elements of the plurality of information elements and the second subcollection comprising a second number of information elements of the plurality of information elements; (b) computer readable program means for causing the computer to determine a first similarity between the first subcollection and the second subcollection; (c) computer readable program means for causing the computer to determine first coordinates for the first subcollection and the second subcollection on the basis of the first similarity; (d) computer readable program means for causing the computer to allocate a first area having first boundaries to the collection such that a first size of the first area is related to a number of information elements of the information; (e) computer readable program means for causing the computer to allocate a second area having second boundaries to the first subcollection such that a second size of the second area is related to the first number; (f) computer readable program means for causing the computer to allocate a third area to the second subcollection such that a third size of the third area is related to the second number; (g) computer readable program means for causing the computer to position the second and third areas within the first boundaries of the first area on the basis of the first coordinates; (h) computer readable program means for causing the computer to calculate a second similarity between a first information element of the first number of information elements and a second information element of the first number of information elements; and (i) computer readable program means for causing the computer to position the first information element and the second information element within the second boundaries in accordance with the second similarity.

Furthermore, the above object is solved by a computer program product directly loadable into an internal memory of a digital computer with the features of claim.

### BRIEF DESCRIPTION OF THE DRAWINGS

For the purpose of illustrating the invention, there is shown in the drawings a form which is presently preferred, it being understood, however, that the invention is not limited to the precise arrangement shown, in which:

FIG. 1 is an exemplary embodiment of the data processing system according to the present invention;

FIG. 2 shows a further exemplary embodiment of the data processing system according to the present invention;

FIG. 3 shows a flow chart of an exemplary embodiment of the method for displaying information according to the present invention;

FIG. 4 shows a flow chart concerning an exemplary embodiment of steps S4 and S10 of FIG. 3;

FIG. 5 shows a flow chart concerning an exemplary embodiment of steps S5 and S11 of FIG. 3;

FIG. 6 shows a flow chart concerning an exemplary embodiment of step S6 of FIG. 3;

FIG. 7 shows a Voronoi diagram for further explaining step S6 of FIG. 3;

FIG. 8 shows a further Voronoi diagram for further explaining step S6 of FIG. 3;

FIG. 9 shows an exemplary embodiment of an image displayed on a display according to the present invention;

FIG. 10 shows another exemplary embodiment of an image displayed on the display according to the present invention;

FIG. 11 shows another exemplary embodiment of an image displayed on the display according to the present invention; and

FIG. 12 shows yet another exemplary embodiment of an image displayed on the display according to the present invention.

### DETAILED DESCRIPTION OF THE PREFERRED EMBODIMENTS OF THE PRESENT INVENTION

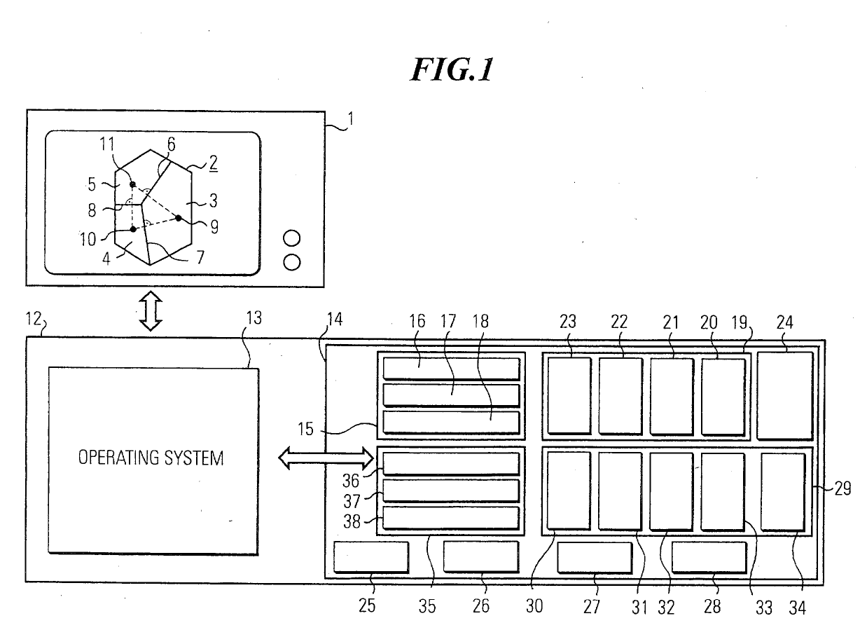

FIG. 1 shows a first exemplary embodiment of the data processing system for displaying information according to the present invention. Preferably, the information includes information elements. Information elements are any kind of structured or unstructured information carrying entities for which a similarity to other information elements can be computed. Examples of information elements are pictures, audio information, customer records, personal records, database records, tactile information or biometric information. In a preferred embodiment of the present invention, information elements are documents.

For the following explanation, it is assumed that the documents are organized in a hierarchy of collections and subcollections. Such a hierarchy is referred to herein as a “collection hierarchy.” Documents, subcollections and collections can be members of more than one parent collection. However, cycles are, preferably, explicitly disallowed. Such a structure is called a directed acyclic graph. In such a directed acyclic graph, no path starts and ends at the same vertex and edges of such a graph are ordered pairs of vertices. As used herein, a graph is referred to as a list of vertices of a graph where each vertex has an edge from it to the next vertex. A vertex is also often referred to as a node. An example for such a collection hierarchy is a classification scheme such as IPC. For example, such a taxonomy is usually maintained manually by an editorial staff. However, the collection hierarchy could also be generated or extracted semi-automatically or automatically.

Documents are assumed to have significant textual content, which may be extracted if necessary with respective tools. Documents are typically electronics, such as ADOBE PDF documents, HTML documents or MICROSOFT WORD documents, but may also comprise spread sheets, tables or graphics.

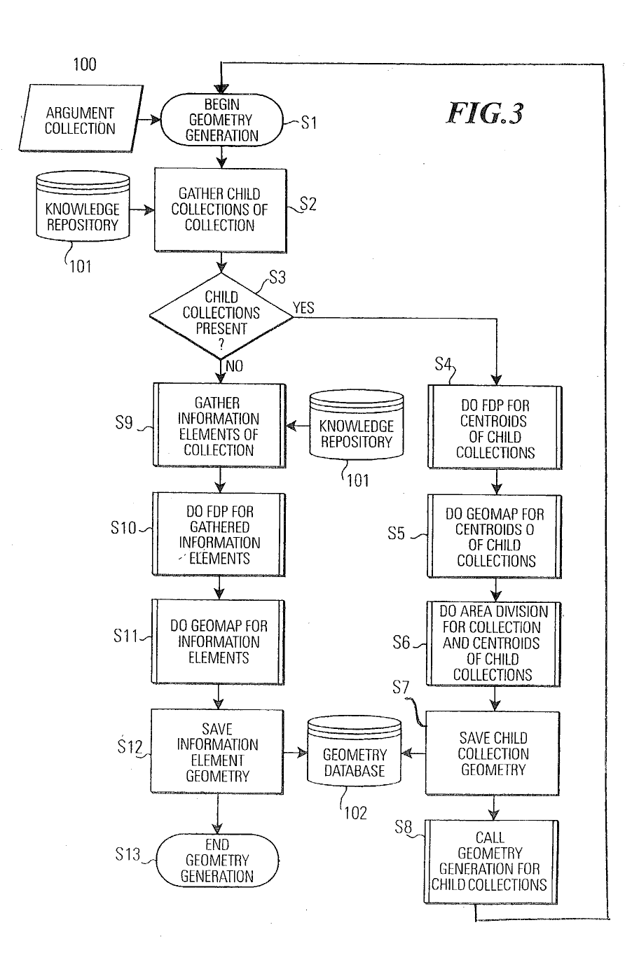

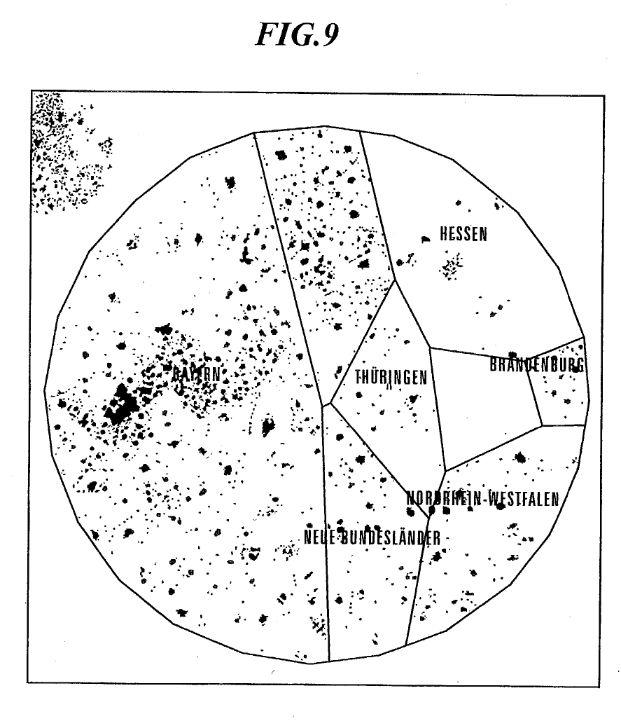

Referring now to the drawing figures, in which like numerals refer to like elements, there is shown in FIG. 1 a display 1 that displays a collection 2 comprising three subcollections, 3, 4 and 5. The collection 2 is displayed by means of a first polygon having a first area corresponding to the number of documents, information elements, subcollections and collections comprised therein. This first area is subdivided by means of bisectors 6, 7 and 8 in the areas of the subcollection 3, 4 and 5, respectively, and are shown centroids 9, 10 and 11. An exemplary embodiment of a method for generating such an image on display 1 will be described below with reference to FIGS. 3 to 8. Further, examples of images visualizing collections will be described with reference to FIGS. 9 to 12.

The display 1 is connected to a calculating section 12. The calculating section 12 preferably comprises an operating system 13 and a processing section 14. Furthermore, communication connection between the processing section 14, the operating system 13 and the display 1 is provided. The processing section 14 comprises means 15 for determining a first similarity between a first subcollection and a second subcollection.

The means 15 for determining the first similarity between the first subcollection and the second subcollection comprises means 16 for calculating a first centroid for a first subcollection and a second centroid for the second subcollection, means 17 for determining the first similarity between the first subcollection and the second subcollection by calculating a third similarity and means 18 for calculating the first coordinates.

Furthermore, processing section 19 comprises means for determining first coordinates for the first subcollection and the second subcollection. The means 19 for determining first coordinates for the first subcollection and the second subcollection comprise means 20 for determining a fourth force, means 21 for determining a third force, means 22 for determining a second force and means 23 for generating second coordinates.

Furthermore, the processing section 14 comprises means for positioning the first information element and the second information element. As shown in FIG. 1, reference number 25 refers to means for controlling the display 1. Reference number 26 refers to means for allocating a third area to the subcollection.

The processing section 14 furthermore comprises means 27 for allocating a second area having second boundaries to the first subcollection and means 28 for allocating a first area having first boundaries to the collection.

Furthermore, the processing section 14 comprises means 29 for calculating a second similarity between a first information element and a second information element. The means 29 for calculating a second similarity between a first information element and a second information element comprise means 30 for calculating the third coordinates, means 31 for generating force coordinates, means 32 for determining a sixth force, means 33 for determining a seventh force 33 and means 34 for determining an eight force.

The processing section 14 furthermore comprises means 35 for positioning the second and third areas. The means 35 for positioning the second and third areas comprises means 36 for arranging, means 37 for determining which of the first and second weights is smaller and means 38 for determining a center.

In an alternative exemplary embodiment, all or some elements of the processing section 14 may be realized as computer readable program means, for example, as modules of program written in a specific programming language. It is also possible, to use programmable chips such as FPGAs or EPLDs, e.g. the FPGAs/EPLDs made by ALTERA, for the elements comprised in the processing section 14.

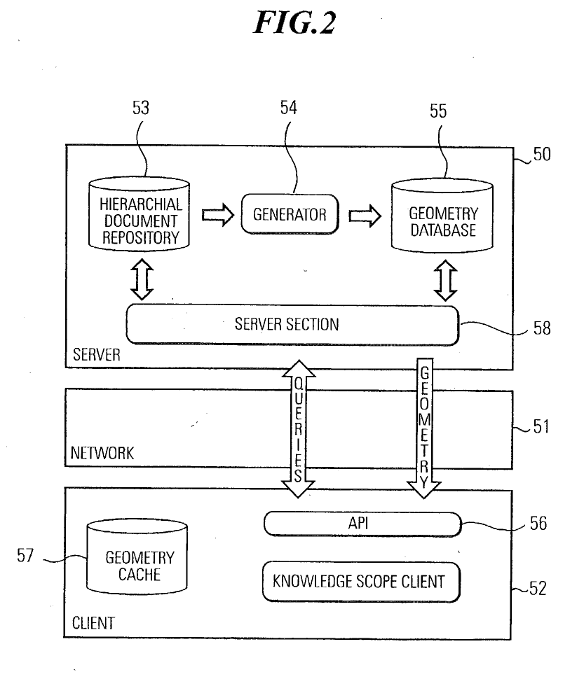

FIG. 2 shows a further exemplary embodiment of the data processing system for displaying information according to the present invention. In FIG. 2, reference number 50 designates a server which is connected to a network 51 which is connected to a client 52. Such a structure is usually referred to as client-server architecture. The server 50 comprises a hierarchical document repository 53 which is connected to a generator 54 which is connected to a geometry database 55. The hierarchical document repository 53 and the geometry database 55 are connected to a server section 58. The server 50 transmits a geometry generated by the server section 58 via network 51 to an API 56 at the client's side of the network 51. On the client's site, there is further provided a geometry cache 57. The client 52 and the server 50 exchange queries via network 51. If the first embodiment of FIG. 1 is realized in a client server architecture as shown in FIG. 1, all elements of the processing section 14 are preferably in the server 50 whereas the display, preferably, would be on the client's site.

FIG. 3 shows an exemplary embodiment of the method for displaying information according to the present invention. Reference number 100 designates an argument. The argument 100 comprises a collection. The collection can comprise a plurality of collections, subcollections and information elements, such as documents. Each of the subcollections and collections comprised in the collection may comprise further collections, subcollections or information elements.

In the following, a preferred embodiment of the method for displaying information according to the present invention is described with a collection, comprising a first subcollection and a second subcollection, the collection comprising a plurality of information elements. The first subcollection comprises a first number of information elements and the second subcollection comprises a second number of information elements.

The numbering of the subcollections and information elements is used for distinguishing the subcollections and information elements from each other and is not intended as a limitation with respect to the number of subcollections or information elements.

Continuing with reference to FIG. 3, in step S1 a process called geometry generation starts with reading the argument. Then the process preferably proceeds to step S2, where child collections of the collection are read from a knowledge repository 101. In the present example, the first and the second subcollections are child-collections of the collection. As noted above, generally a collection may also contain documents. In such a case, an additional artificial subcollection is generated and the documents are placed in this additional artificial subcollection. Then, from step S2, the method proceeds to step S3.

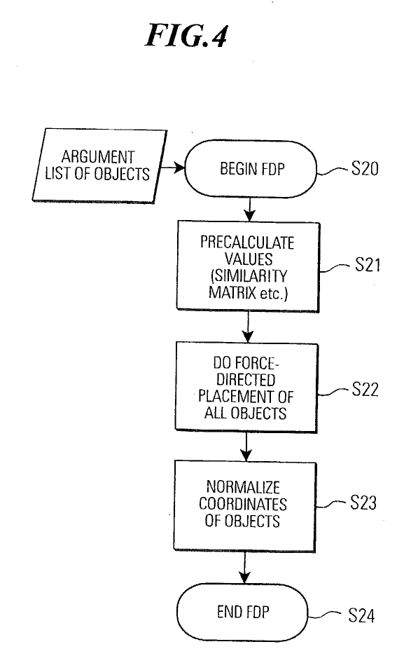

In step S3, there is a determination made whether there are child collections present or not. In case the question in S3 is answered with YES (i.e. there are child collections), the method continues to step S4. In step S4 a force-directed placement (“FDP”) is carried out for the child collections. The FDP is an iterative method for mapping a set of high-dimensional vectors to a low-dimensional space while preserving a high-dimensional relation as far as possible. The algorithm calculates force vectors from similarities between respective elements. In the present example, in step S4, force-vectors are calculated from the similarities between a first centroid of the first subcollection and a second centroid of the second subcollection. A centroid is a respective center of gravity of the respective subcollection. In step S4, there are generated normalized coordinates for the centroids of the child collections, that is in the present example, normalized coordinates for the centroids of the first and second collections. Step S4 is described with further detail with reference to FIG. 4.

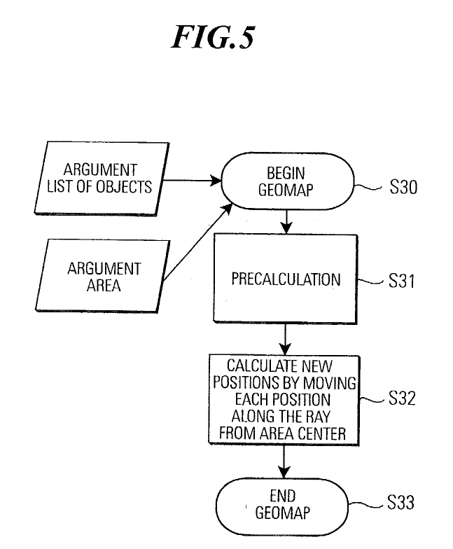

After step S4, the method proceeds to step S5 where a geomap procedure is carried out for the centroids of the child collections. In the present example, the geomap procedure is carried out for the centroids of the first and second subcollections. The purpose of the geomap procedure is to efficiently use an area allocated to the respective collection or respective subcollection. In the geomap procedure, areas are assigned to the child collections and the coordinates calculated for the centroids of the child collections are inscribed into these areas. Preferably these areas are polygons. With respect to the present example, a first area is assigned to the first subcollection and a second area is assigned to the second subcollection. A size of the first area corresponds to a number of information elements comprised in the first subcollection and a size of the second area corresponds to a number of information elements comprised in the second subcollection. In case the first subcollection comprises a further collection and a further subcollection, a total amount of information elements comprised in the first subcollection is calculated and is the basis for a size of the first area. The geomap procedure outputs new positions for the centroids of the child collections. Hence, with reference to the present example, the geomap procedure calculates new positions within the first and second areas for the centroid of the first and second subcollections. The geomap procedure carried in S5 is described below in more detail, with reference to FIG. 5.

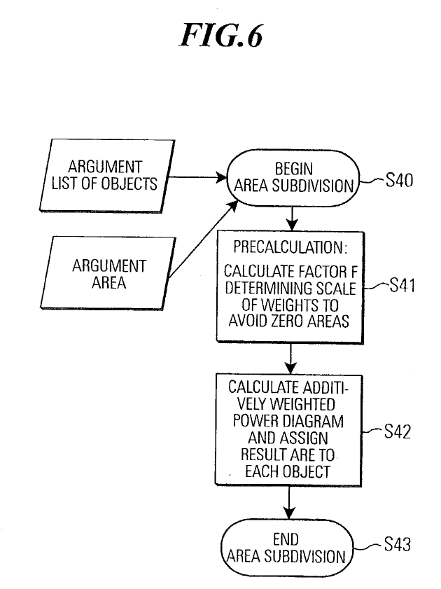

After step S5, the method proceeds to step S6, where an area division is carried for the centroid of child collections. With reference to the present example, an area division is carried out for the centroid of the first and second collection. In other words, in step S6, all assigned areas comprising the respective information elements and centroids with the positions determined in step S5 are arranged such that the size of the respective area corresponds to the number of information elements comprised in the area, and such that all areas are inscribed into one “parent-area” assigned to the collection. With respect to the present example, the first and second areas are inscribed into a third area which was allocated to the collection. Step S6 is described below in more detail with respect to FIG. 6.

After S6, the method proceeds to S7 where the results of S6 are saved in a geometry database 102. Then, the method continues to step S8 where the geometry generation is called again for the child collections. Thus, from step S8, the method recursively continues to step S1 which is carried out in the same way as before. The method continues then to step S2 which is carried out in the same way as before. And, in step S3, the query is carried out, whether there are child collections present or not. In case there are child collections, the method continues to steps S4 and step S4 to S8 are carried out as described above. In case there are no child-collections present, the method continues to step S9.

In step S9, the information elements comprised in the collection are gathered from the knowledge repository 101. With respect to the present example, the information elements comprised in the first and second subcollections are gathered from the knowledge repository 101. Then, the method proceeds to step

In step S10, an FDP is carried out for the information elements. This is carried out in the same way as described with reference to step S4, except that the FDP in step S10 is carried out for the information elements and not for the centroids of child collections, as in step S4. The FDP is described below in more detail with reference to FIG. 4. Then, the method proceeds to step S11.

In step S11, the geomap procedure is carried out for calculating coordinates and respective areas for the information elements. This is carried out in the same way as described above with reference to step S5, except that the geomap procedure in step S11 is carried out for the information elements. The geomap procedure is described below in more detail with reference to FIG. 5. Then, the method proceeds to step S12.

In step S12, a geometry of the information elements is stored in the geometry database 102. With respect to the present example, coordinates of the information elements of first and second subcollections are stored in the geometry data base. Then, the method proceeds to step S13 where the method ends.

The force-directed placement is now described in more detail with reference to FIG. 4.

As already indicated with reference to FIG. 3, the method steps of FIG. 4 are performed in step S4 of FIG. 3 and in step S10 of FIG. 3. Since, in step S4, the FDP is carried out for centroids of child collections and, in step S10, for information elements, the term “object” is used to generally refer to the centroids and the information elements. In other words, if the method steps of FIG. 4 carried for step S4 of FIG. 3, the objects are centroids of child collections and if the steps of FIG. 4 are carried out for step S10 of FIG. 3, the objects are information elements.

Steps S20 to S24 of FIG. 4 are an iterative method for mapping a set of high-dimensional vectors to a low-dimensional space, while preserving the high-dimensional relations as far as possible. These method steps determine force vectors from similarities between objects. These force vectors and further, custom-defined vectors influence positions i.e. coordinates of points representing the object at each iteration, for example, in this message.

The FDP starts in step S20 with reading the argument, namely a list of the respective objects. Then, the method continues to step S21 where necessary values are precalculated. This will be described with further detail in the following.

The high-dimensional vector representation allows comparison of a pair of objects by computing a similarity between them. Here, a cosine similarity metric is used. If Dᵢ and Dⱼ are documents to be compared, L is the dimensionality of the high-dimensional space and x_{iq} is the q'th component of the term vector which represents the object Dᵢ. The cosine similarity of two objects Dᵢ, Dⱼ is given by:

$$sim ( {D}_{i} , {D}_{j} ) = \frac{{\sum }_{k = 1}^{L} ( {x}_{i , k} {x}_{j , k} )}{\sqrt{{\sum }_{k = 1}^{L} {x}_{i , k}^{2} {\sum }_{k = 1}^{L} {x}_{j , k}^{2}}} .$$

In the above equation, xᵢ and xⱼ are feature vectors where vector components correspond to different features. Apart from the cosine similarity, other similarity coefficients can be used, for example, Dice and Jaccard.

In a preferred embodiment, all inter-object similarity values, i.e. all similarities between all objects, are precalculated and subsequently stored in a similarity matrix. With respect to the present example, in step S4 of FIG. 3, a similarity value is calculated for the centroids of the first and second subcollections. With respect to step S10 of FIG. 3 according to the present example, similarity values are calculated for the information elements. Then, the method continues to step S23.

In step S22, objects are initially placed randomly in a low-dimensional space and are then moved based on forces between the objects, wherein the forces are determined on the basis of the similarities between the objects. A low-dimensional space corresponds to the space of the display, i.e., the low-dimensional space is 1 dimensional for a 1 dimensional display, 2 dimensional for a 2 dimensional display and 3 dimensional for a 3 dimensional display, etc. The forces preferably may respectively comprise an attractive component and a repulsive component. In the following, this is described for an exemplary embodiment for a two-dimensional space wherein forces between two respective objects are respectively calculated.

The force force(Dᵢ Dⱼ) between two objects has three components: An attractive component proportional to the similarity sim(Dᵢ, Dⱼ)^{d} between the two objects, a repulsive component 1/(dist(Dᵢ, Dⱼ)) inversely proportional to a two-dimensional distance between these two objects and a weak gravitational component grav:

$$force ( {D}_{i} , {D}_{j} ) = sim {( {D}_{i} , {D}_{j} )}^{d} - \frac{w}{dist ( {D}_{i} , {D}_{j} )} + grav .$$

The first component, namely the attractive component pulls objects with similar content together. d>=1 is a discriminator which is adjusted to characteristics of the similarity matrix calculated in step S21. With the discriminator d, a separation of a layout of the elements on the display can be improved significantly. The factor w is 1 in the case of placing documents (S10) and in the case of centroids (S4) proportional to the weight of the centroid, e.g. to the numbers of documents recursively contained in the corresponding collection.

The second component, i.e. the repulsive component pushes two objects apart and prevents them from coming too close. The third component, namely the gravitational component is a weak but constant gravitational force which provides cohesion to the object set by ensuring that even very dissimilar objects attract each other once they become very distant.

New coordinates of objects are calculated by letting one object interact with other objects from the list of objects followed by a subsequent averaging of the results over all interactions. For example, Dᵢ.x, a new x-coordinate of object Dᵢ, is calculated with the following equation. The other coordinates are calculated accordingly.

$${D}_{i} \cdot x = \frac{1}{N - 1} {\sum }_{j = 1 , j \neq i}^{N} force ( {D}_{i} , {D}_{j} ) * {D}_{j} \cdot x + ( 1 - force ( {D}_{i} , {D}_{j} ) ) * {D}_{i} \cdot x .$$

Thus, at each iteration a new position is computed for every object and the iteration continues until a termination condition is satisfied. A commonly used termination condition of mechanical stress is computationally intensive. Therefore, a more light-weight, adaptive condition is used which can be summarized as: an execution terminates when object positions are stabilized sufficiently or when a maximum number of iterations is reached.

Assuming a set of N objects, for the calculation of an influence of every object with respect to every other object, each object would have to interact with M=N−1 other objects. This results in a quadratic time complexity for each iteration. However, if M may be held constant, a linear execution time (per iteration) can advantageously be reached. To do this, a method described in Chalmers (1996). A Linear Iteration Time Layout Algorithm for Visualizing High-Dimensional Data. In Proc. Visualization '96, pages 127-132, San Francisco, Calif. (1996). IEEE Computer Society. http://www.dcs.gla.ac.uk/~matthew/papers/vis96.pdf which uses stochastic sampling, is used where each object maintains two small sets of constant size. A first set, which may also be called the random set, is filled with random elements during every iteration. And a second set, which may also be called neighbor set, maintains a list of similar, neighboring objects. In each iteration, members of the neighbor set are compared to new samples in the random set and are replaced by objects which are more similar. The combination of this processing combination with the invention method allows a very stable and fast calculation. Hence, a calculation time of the invention method is minimized and use of computing resources for the data processing system according to the present invention are minimized.

For performance reasons, the invention method preferably does not use any velocities or viscosities. As a result of the above described random sampling, a certain amount of jitter is introduced. This jitter can cause a small inaccuracy of the computed position of the respective objects. However, this jitter proved to be useful for avoiding local minima. In other words, the sampling described above introduces little computing overhead, but requires the same number or fewer iterations than a method without sampling in order to reach a stable layout.

Once a layout satisfying the termination condition has been calculated with the sampling procedure, a number of iterations are performed by using the process without sampling. The number of iterations without sampling is in relation to an amount of interactions performed by the sampling procedure. The effect is that the calculation time is not significantly increased. The performance of a few iterations with the process without sampling almost eliminates the layout inaccuracy introduced by the sampling, without compromising the time complexity.

By step S22 (FIG. 4), centroids having a smaller weight are placed close to the center of the surrounding boundary polygon. Centroids having a higher weight are placed in a ring midway between the center of the polygon and its boundary. Thus, advantageously, a correspondence between the weight of the centroid and the size of the allocated area is achieved.

Once the force-directed placement (FDP) of all objects is finished in step 22 and all respective coordinates are calculated for the object, the method continues to step S23 where the coordinates calculated in step S22 are normalized. After the normalization step S23, the method continues to step S24 where the FDP process ends.

The geomap procedure carried out in step S5 of FIG. 3 for centroids of child collections and in step S11 of FIG. 3 for information elements is now described in further detail with reference to FIG. 5. As mentioned with respect to FIG. 4, the term “objects” is used to refer to both information elements and centroids of child collections. In step S30, where the geomap procedure begins, the argument of the procedure, namely the list of objects and the respective areas belonging to these objects are read. Then, in a precalculation step S31, area vertices are transformed into the same normalized space as the FDP coordinates. Then, the method continues to step S32 where new positions are calculated such that each object is assigned a position which falls within the boundaries defined by the vertices. After new positions are calculated by moving each existent position along the way from the center of the respective area as performed in step S32, the method of FIG. 5 proceeds to step S33 where it ends.

Referring now to FIG. 6, the area division carried out in accordance with step S6 of FIG. 3 is described in more detail. The task performed in the area division may be described as follows: considering one level of the collection hierarchy in the repository, there are N points pᵢ of known weight wᵢ representing the objects on this level in the current collection. As mentioned with respect to FIG. 4, the objects may be collections, subcollections, information elements or documents. These points pᵢ are placed within a given polygonal area A which is read in step S40. The polygonal area A represents the area of the collection. The task performed in steps S41 and S42 is to find a partition of area A into N subareas Aᵢ which satisfies the following condition:

pᵢεAᵢ

Aᵢ being convex

Aᵢ˜Wᵢ, and

Aᵢ having a size not smaller than a preset minimum value.

With respect to the example used with reference to FIG. 3, steps S41 and S42 in FIG. 5 would be for the calculation of a partition of the area of the collection into the first area for the first collection at the second area for the second collection period. In step S11 of FIG. 3, steps S41 and S42 would be for the calculation of partitions of the first and the second areas of the first and second subcollections in respective areas corresponding to the information elements respectively comprised in the first and second subcollections.

The determination of area subdivisions may be accomplished by using e.g. an additively weighted power Voronoi diagram. The additively weighted Voronoi diagram is known for example from Ukabi, A. Boots, B. Sugihara K., and Chew S. N.(2000) Spatial Tessellations: Concepts and Applications of Voronoi diagrams. Wiley, Second Edition. According to the Voronoi diagram, an area of each polygon assigned to each object is related to the weight of the respective object. For example, an object p₀ with a weight of 20 is allocated a larger area than an object p₂ with a weight of 15, and they are both assigned an area larger than an area of an object p₁ having a weight of 10.

For two points p and pᵢ, the additively weighted power distance is given by:

d_{pw}(p, pᵢ; wᵢ)=∥\vec{p}−\vec{p}ᵢ∥²−wᵢ. (equation A)

This equation may used for determining a position of a bisector b (p, pᵢ) perpendicular to the interconnecting line between p and pᵢ, the bisector forming an edge of the polygon around p.

However, the additively weighted power distance calculated in accordance with the above equation has the disadvantage that if the weight difference between two objects is very large and these objects are close to each other, the object having smaller weight may be placed on the wrong site of the bisector and hence outside its own area. Thus, in order to ensure that each objects pᵢ lies within its own area Aᵢ, according to the present invention, each wᵢ is scaled with a global factor f such that all bisectors b (pᵢ, pⱼ) are placed between pᵢ and pⱼ:

d_{pw}(p, pᵢ; wᵢ)=∥\vec{p}−\vec{p}ᵢ∥²−fwᵢ. (equation B)

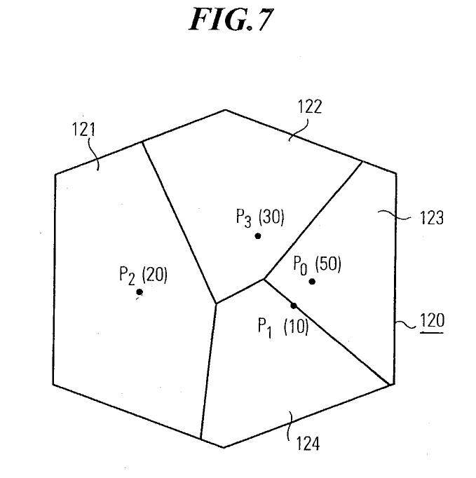

Instead of equation B, a number of other distance equations may be used, such as the multiplicatively weighted Voronoi distance, or the additively weighted Voronoi distance. Advantageously, equation B leads to polygons with straight boundaries which are easy to display. The factor f of the above equation is defined as maximum scale factor which can be uniformly applied to all weights without causing a bisector to overrun. The factor f is calculated in accordance with the above modified equation in step S41. However, since the outer polygon boundaries are fixed and only the inner boundaries (bisectors) can slide, the introduction of the scale factor f may cause that an area Aᵢ is no longer exactly related to its weight wᵢ corresponding to the total number of information elements within this area. This may occur when relatively light objects are placed close to the margin of the polygon or are placed in between a number of other objects. Such a case is shown in FIG. 7.

In FIG. 7, there is shown a collection having an area 120 which defines outer boundaries of the area of the collection. The area 120 has a form of a polygon. Within the boundaries of area 120, there is a subcollection 121 having a centroid p₂. The centroid p₂ is the geometrical point of gravity of the subcollection 121. The subcollection 121 has a weight of 20 and thus should have an area within the area of the collection 120 corresponding to the weight of 20. Reference number 122 designates a collection within the area of the collection 120. The centroid, i.e. the graphical center of gravity of the collection 122 is p3. The weight of the collection 122 is 30. Thus, an area corresponding to 30 should be assigned to the collection 122. Reference number 123 designates a further subcollection having a weight of 50 and having the centroid p₀. Reference number 124 designates a further subcollection having a weight of 10. By following the above known equation (equation (A)), as can be clearly seen from FIG. 7, the area of the subcollection 124 has approximately the same size as the area of the subcollection of the area 123. However, according to the weight of the subcollection 124 and the subcollection 123, the area of the subcollection 124 should only be one fifth of the area of the subcollection 123.

In addition to that, as shown in FIG. 7, the centroid p₁ is located on the bisector b (p₀, p₁) which forms the boundary between the subcollection 124 and the subcollection 123. According to one aspect of the present invention, by using the scale factor f (equation B), a centroid being located too close to the bisector, or on the bisector as shown in FIG. 7, is avoided.

Advantageously, by step S22 of FIG. 4, centroids having a smaller weight are placed close to the center of the surrounding boundary polygon. Objects having a higher weight are placed in a ring midway between the center of the polygon and its boundary.

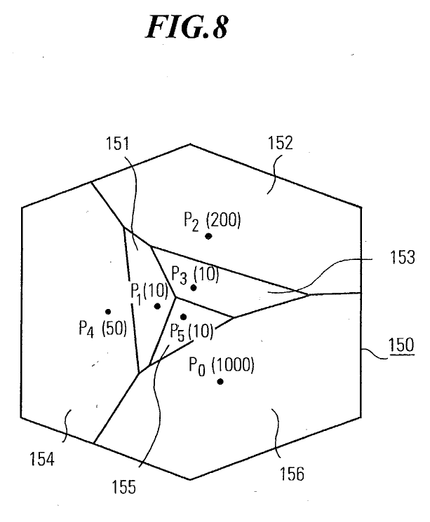

FIG. 8 shows the result of placing objects with a smaller weight close to the center of the surrounding boundary polygon while putting heavier objects in a ring midway between the center of the boundary polygon and the center and the use of equation B. In the polygon of the area of the collection 150, there is a subcollection 151 with a centroid p₁ having a weight of 10, a subcollection 152 having a weight of 200 and a centroid p₂, a subcollection 153 having a weight of 10 and a centroid p₃, a subcollection 154 having a weight of 50 and a centroid p₄, a subcollection 155 having a weight of 10 and a centroid p₅, and a subcollection 156 having a weight of 1000 and a centroid p₀.

As can be clearly taken from FIG. 8, subcollections 156, 152 and 154 having a higher weight are placed close to the boundaries of the collection 150. In contrast, the subcollections 151, 153 and 155 having a significant lighter weight are placed close to the center of the area of the collection 150. In addition, a relation of the size of the respective subcollection and the weight is kept. As shown in FIG. 8, the area of the subcollection 156 is significantly bigger than, for example, the area of the subcollection 155. Furthermore and advantageously, the centroids of the respective subcollection 151 to 156 are always within the boundaries of the respective areas, and there is a sufficient distance between the respective centroid and its boundary.

After the calculation step S42, the method of FIG. 6 proceeds to step S43 and ends.

FIG. 9 shows an image or layout as displayed on the display 1 (FIG. 1) according to the present invention. As shown in FIG. 9, the objects, documents or information elements are displayed in the form of a “galaxy.” Single objects are visualized as stars with similar objects forming clusters of stars. Collection or subcollections are visualized as polygons bounding clusters and stars, resembling the boundaries of constellations in the night sky. Collections featuring similar content are placed close to each other as far as the hierarchical structure of the repository allows. Empty areas remain where objects are hidden, for example, due to access restrictions for a particular user, and resemble dark nebulas as found quite frequently within real galaxies. As can be seen in the upper left corner of FIG. 9, there is provided an overview over the whole night sky. In the main polygon shown in FIG. 9 which has approximately the form of a circle, there are collections and subcollections relating to “Bayern,” “Berlin,” “Hessen,” “Brandenburg,” “Nordrhein-Westfalen,” “Neue Bundesländer” and “Thüringen.” The image shown in FIG. 9 was derived from a collection of approximately 100,000 articles in the German language which were published during the years 1997 to 2000 in the Süddeutsche Zeitung, which is a German daily newspaper. These articles have been classified thematically by the newspaper editorial staff into around 9,000 collections and subcollections up to 15 levels deep. In FIG. 9, the constellation boundaries and labels are shown for the topmost level of the hierarchy.

As obvious from FIG. 9, approximately 50% of the articles relate to “Bayern” which is the state of Germany where the Süddeutsche Zeitung is published. The number of articles relating to other states of Germany is significantly less. The galaxy itself is complete in the sense that it displays all the stars, i.e. objects or information elements it contains, down to the bottommost level of the hierarchy. However, as shown in FIG. 9, no individual stars are discernable in the figures. The clusters forming the galaxy consist of thousands of stars which, in accordance with a metaphor of a telescope, can only be resolved individually at a higher magnification.

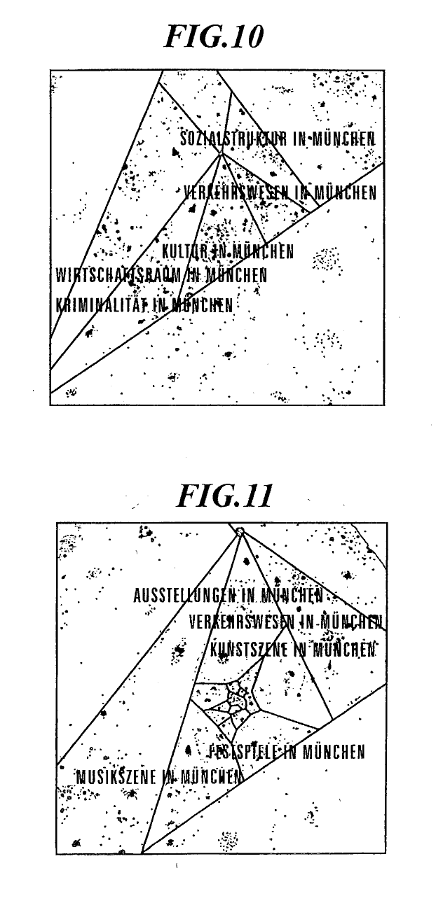

In the following, the telescope metaphor is described in more detail. For example, a user is interested in further information on a specific cluster of stars, and the user points his telescope to the bright cluster of stars just underneath the “Bayern.” Then, with an increased magnification, the user sees this cluster in more detail as shown in FIG. 10.

As shown in FIG. 10, this very bright cluster relates to the city of Munich which is the city where the Süddeutsche Zeitung is published. Within this cluster, revealed by the increased magnification, further collections and subcollections are now visible. For example, within “München,” there are visible subcollections or collections relating to “Wirtschaftsraum München” which can be translated as “the economic area of Munich,” “Kriminalität in München” which can be translated into “criminality in Munich,” “Kultur in München” which can be translated into “culture in Munich,” “Verkehrswesen in München,” which can be translated into “traffic in Munich” and “Sozialstruktur in München,” which can be translated into “social structure in Munich.”

If the user pinpoints his telescope to the cluster “Kultur in München,” the user may see an image such as the one in FIG. 11. In FIG. 11, there are big subcollections relating to “Ausstellungen in München” which may be translated into “exhibitions in Munich,” “Festspiele in München” which can be translated into “Festivals in Munich,” “Kunstszene in München,” which can be translated into “Art in Munich” and “Musicszene in München,” which can be translated into “the music scene of Munich.” As can further be seen from FIG. 11, the subcollections having a smaller weight are arranged in the center of these polygons and are not explicitly discernable with this magnification. In case the user is interested in the subcollections in the center of FIG. 11, the user has to pinpoint the telescope on this area. The zooming performed by the metaphoric telescope is performed by a zooming option on the display one of FIG. 1 which may be activated by use of a zooming button which can be activated by the user by means of a cursor device.

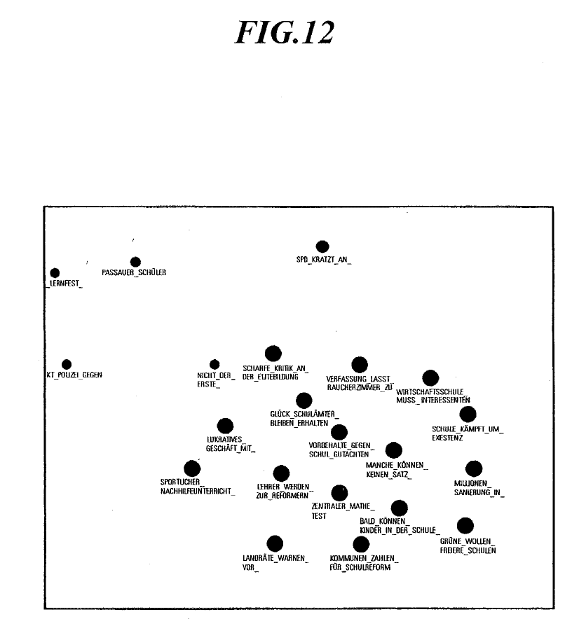

FIG. 12 shows an image where the user has selected a very high resolution which shows the individual information elements or documents which are labeled by the respective meta information comprising for example author, publication date and title.

With exemplary embodiments of the present invention, it is possible to visualize very large (millions of entities), such as hierarchically structured document repositories (scalability). Furthermore, advantageously, both the hierarchical organization of the documents and the inter-document similarity may be presented within a single, consistent visualization (hierarchy plus similarity). In addition, both a global and a local view of the information space are integrated into one seamless visualization (focus plus context). Also, advantageously, with, for example, the “telescope,” simple, intuitive navigation, exploration, and manipulation facilities are provided (interaction). In addition to that, with the exemplary embodiments of the present invention it is possible to support a single, consistent view of the document space for all users, regardless of the access rights of each individual user, thus providing a common frame of reference for all parties, and providing a united view.

The design of the visualization metaphor in accordance with exemplary embodiments of the present invention, advantageously may allow the visualization to display a maximum number of document properties and relationships without requiring the user to take action. For example, it is possible to show an age of documents with different colors or different shapes in the visualization. Thus, advantageously, exemplary embodiments of the present invention may allow a location of documents without specifying a query, by simply browsing the information space. Furthermore, the exemplary embodiments of the present invention may feature a number of additional information channels to which users may map document properties of their choice, again replacing explicit queries with navigation.

As a paramount advantage, exemplary embodiments of the present invention may facilitate memorability, in the sense of enabling users to visually recall locations within the information space, without having to remember long document names or lengthy path information. Advantageously, according to exemplary embodiments of the present invention, the visualization remains basically unchanged at a global level even if changes occur to the underlying document repository on a local level. Also, according to exemplary embodiments of the present invention it is possible to present the same visualization to different users in collaborative work environments, where each user might have different access rights. If every user were presented with a different visualization of the same information space, communication between users could not be based on the same frame of reference, strongly reducing its practical usability.

What is claimed is:

1. A method for displaying information comprising a plurality of information elements on a display, the information being organized in a collection comprising a first subcollection and a second subcollection, the first subcollection comprising a first number of information elements of the plurality of information elements and the second subcollection comprising a second number of information elements of the plurality of information elements, the method comprising:
(a) determining a first similarity between the first subcollection and the second subcollection;
(b) determining first coordinates for the first subcollection and the second subcollection in accordance with the first similarity;
(c) allocating a first area having first boundaries to the collection such that a first size of the first area is related to a number of information elements of the information;
(d) allocating a second area having second boundaries to the first subcollection such that a second size of the second area is related to the first number;
(e) allocating a third area to the second subcollection such that a third size of the third area is related to the second number;
(f) positioning the second and third areas within the first boundaries of the first area in accordance with the first coordinates;
(g) determining a second similarity between a first information element of the first number of information elements and a second information element of the first number of information elements; and
(h) positioning the first information element and the second information element within the second boundaries in accordance with the second similarity.

2. The method according to claim 1, wherein the step (a) further comprises:
calculating a first centroid for the first subcollection and calculating a second centroid for the second subcollection; and
determining the first similarity between the first subcollection and the second subcollection by calculating a third similarity between the first centroid and the second centroid.

3. The method according to claim 2, wherein the first and second centroids are respective geometrical centers of gravity of the second and third areas.

4. The method according to claim 2, wherein the step (f) further comprises:
determining a center of the first area;
determining which weight of the first and second weights is a smaller weight; and
arranging a centroid of the first and second centroids having the smaller weight closer to the center than the remaining centroid of the first and second centroids.

5. The method according to claim 2, wherein the second boundary is located between the second area and the third area and is determined by a perpendicular bisector b(p, pᵢ) which is perpendicular to a straight line (\overline{ppᵢ}) between the first centroid and the second centroid, with p being first coordinates of the first centroid, pᵢ being second coordinates of the second centroid.

6. The method according to claim 5, wherein a second distance between the first centroid and a point of intersection of the perpendicular bisector b(p, pᵢ) and the straight line (\overline{ppᵢ}) is calculated by means of the following equation:
d_{pw}(p, pᵢ; wᵢ)=∥\vec{p}−\vec{p}ᵢ∥²−fwᵢ;
with d_{pw}(p, pᵢ; wᵢ) being the second distance which is additively weighted, with p being the first coordinates of the first centroid, pᵢ being the second coordinates of the second centroid and wᵢ being the second weight and f being a scale factor.

7. The method according to claim 6, wherein the scale factor f is a global scale factor to ensure that the perpendicular bisector b(p, pᵢ) is between the first centroid and the second centroid.

8. The method according to claim 2, wherein the first centroid is given a first weight and the second centroid is given a second weight, wherein the first weight corresponds to the first number and the second weight corresponds to the second number.

9. The method according to claim 8, wherein the step (f) further comprises:
determining a center of the first area;
determining which weight of the first and second weights is a smaller weight; and
arranging a centroid of the first and second centroids having the smaller weight closer to the center than the remaining centroid of the first and second centroids.

10. The method according to claim 8, wherein the second boundary is located between the second area and the third area and is determined by a perpendicular bisector b(p, pᵢ) which is perpendicular to a straight line (\overline{ppᵢ}) between the first centroid and the second centroid, with p being first coordinates of the first centroid, pᵢ being second coordinates of the second centroid.

11. The method according to claim 2, wherein the step (b) further comprises calculating the first coordinates on the display for the first and second centroids by using a first force between the first and second centroids.

12. The method according to claim 2, wherein the third similarity is calculated in accordance with the following equation:
$$sim ( {D}_{i} , {D}_{j} ) = \frac{{\sum }_{k = 1}^{L} ( {x}_{i , k} {x}_{j , k} )}{\sqrt{{\sum }_{k = 1}^{L} {x}_{i , k}^{2} {\sum }_{k = 1}^{L} {x}_{j , k}^{2}}}$$
with sim(Dᵢ, Dⱼ) being the third similarity, Dᵢ being the first centroid and Dⱼ being the second centroid, L being a dimensionality and x_{i,q} being a q'th component of a term vector representing the first centroid.

13. The method according to claim 12, wherein the step (b) further comprises calculating the first coordinates on the display for the first and second centroids by using a first force between the first and second centroids.

14. The method according to claim 13, wherein the first force is calculated in accordance with the following equation:
$$force ( {D}_{i} , {D}_{j} ) = sim {( {D}_{i} , {D}_{j} )}^{d} - \frac{w}{dist ( {D}_{i} , {D}_{j} )} + grav$$
wherein force(Dᵢ, Dⱼ) is the first force, sim(Dᵢ, Dⱼ)^{d} is the second force,
$$\frac{w}{dist ( {D}_{i} , {D}_{j} )}$$
is the third force with w being proportional to at least one element of the group consisting of the first and second number, dist(Dᵢ, Dⱼ) is the first distance and grav is the fourth force and wherein Dᵢ is the first centroid and Dⱼ is the second centroid and d is a discriminator, with d>=1.

15. The method according to claim 13, wherein the step (b) further comprises
generating second coordinates on the display for the first and second centroids at random;
determining a second force which is attractive and which is proportional to the third similarity; and
determining a third force which is inversely proportional to a first distance between the first and second centroids on the basis of the second coordinates; and
determining a fourth gravitational force, wherein the first force comprises the second, third and fourth forces.

16. The method according to claim 15, wherein the first force is calculated in accordance with the following equation:
$$force ( {D}_{i} , {D}_{j} ) = sim {( {D}_{i} , {D}_{j} )}^{d} - \frac{w}{dist ( {D}_{i} , {D}_{j} )} + grav$$
wherein force(Dᵢ, Dⱼ) is the first force, sim(Dᵢ, Dⱼ)^{d} is the second force,
$$\frac{w}{dist ( {D}_{i} , {D}_{j} )}$$
is the third force with w being proportional to at least one element of the group consisting of the first and second number, dist(Dᵢ, Dⱼ) is the first distance and grav is the fourth force and wherein Dᵢ is the first centroid and Dⱼ is the second centroid and d is a discriminator, with d>=1.

17. The method according to claim 1, wherein the first coordinates are determined in accordance with the following equation:
$${D}_{i} \cdot x = \frac{1}{N - 1} {\sum }_{j = 1 , j \neq i}^{N} force ( {D}_{i} , {D}_{j} ) * {D}_{j} \cdot x + ( 1 - force ( {D}_{i} , {D}_{j} ) ) * {D}_{i} \cdot x$$
wherein D_{i.}x is an x-coordinate of the first coordinates, force(Dᵢ, Dⱼ) is the first force, wherein N is a total amount of information elements of the information.

18. The method according to claim 1, wherein the second similarity is calculated in accordance with the following equation:
$$sim ( {E}_{u} , {E}_{v} ) = \frac{{\sum }_{l = 1}^{L} ( {y}_{u , l} {y}_{v , l} )}{\sqrt{{\sum }_{l = 1}^{L} {y}_{u , l}^{2} {\sum }_{l = 1}^{L} {y}_{v , l}^{2}}}$$
with sim(Eᵤ, Eᵥ) being the second similarity, Eᵤ being the first information element and Eᵥ being the second information element, L being a dimensionality and y_{u,q} being a q'th component of a term vector representing the first information element.

19. The method according to claim 1, wherein the step (g) further comprises calculating the third coordinates on the display for the first and second information elements by using a fifth force between the first and second information elements.

20. The method according to claim 19, wherein the fifth force is calculated in accordance with the following equation:
$$force ( {E}_{u} , {E}_{v} ) = {sim ( {E}_{u} , {E}_{v} )}^{e} - \frac{1}{dist ( {E}_{u} , {E}_{v} )} + grav$$
wherein force(Eᵤ, Eᵥ) is the fifth force, sim(Eᵤ, Eᵥ)^{e} is the sixth force,
$$\frac{1}{dist ( {E}_{u} , {E}_{v} )}$$
is the seventh force, dist(Eᵤ, Eᵥ) is the third distance and grav is the eight force and wherein Eᵤ is the first information element and Eᵥ is the second information element and e is a discriminator, with e>=1.

21. The method according to claim 19, wherein the step (g) further comprises:
generating fourth coordinates on the display for the first and second information elements at random;
determining a sixth force which is attractive and which is proportional to the second similarity;
determining a seventh force which is inversely proportional to a third distance between the first and second information elements on the basis of the fourth coordinates; and
determining an eighth gravitational force, wherein the fifth force comprises the sixth, seventh and eighth forces.

22. The method according to claim 21, wherein the fourth coordinates are determined in accordance with the following equation:
$${E}_{u} \cdot x = \frac{1}{N - 1} {\sum }_{v = 1 , v \neq u}^{N} force ( {E}_{u} , {E}_{v} ) * {E}_{v} \cdot x + ( 1 - force ( {E}_{u} , {E}_{v} ) ) * {E}_{v} \cdot x$$
wherein E_{u.x} is an x-coordinate of the fourth coordinates, force(Eᵤ, Eᵥ) is the fifth force.

23. The method according to claim 21, wherein the fifth force is calculated in accordance with the following equation:
$$force ( {E}_{u} , {E}_{v} ) = {sim ( {E}_{u} , {E}_{v} )}^{e} - \frac{1}{dist ( {E}_{u} , {E}_{v} )} + grav$$
wherein force(Eᵤ, Eᵥ) is the fifth force, sim(Eᵤ, Eᵥ)^{e} is the sixth force,
$$\frac{1}{dist ( {E}_{u} , {E}_{v} )}$$
is the seventh force, dist(Eᵤ, Eᵥ) is the third distance and grav is the eight force and wherein Eᵤ is the first information element and Eᵥ is the second information element and e is a discriminator, with e>=1.

24. The method according to claim 23, wherein the fourth coordinates are determined in accordance with the following equation:
$${E}_{u} \cdot x = \frac{1}{N - 1} {\sum }_{v = 1 , v \neq u}^{N} force ( {E}_{u} , {E}_{v} ) * {E}_{v} \cdot x + ( 1 - force ( {E}_{u} , {E}_{v} ) ) * {E}_{v} \cdot x$$
wherein E_{u.x} is an x-coordinate of the fourth coordinates, force(Eᵤ, Eᵥ) is the fifth force.

25. The method according to claim 1, further comprising the step of displaying the first, second and third areas and the first number of information elements and the second number of information elements, wherein each information element of the first and second number of information elements is represented as a graphic sign such that an image displayed on the display resembles an area of a night sky as seen trough a telescope or as seen by a naked eye.

26. The method according to claim 25, wherein the graphic sign is one of a shape or pixel on the display, wherein properties of the shape or pixel express properties of the respective information elements of the plurality of information elements.

27. The method according to claim 1, wherein the first, second and third areas are polygons.

28. The method according to claim 1, wherein the information elements are selected from a group consisting at least of documents, subcollections and collections.

29. A data processing system for displaying information, comprising a display, and an operating system, wherein the information comprises a plurality of information elements, wherein the information is organized in a collection comprising a first subcollection and a second subcollection, the first subcollection comprising a first number of information elements of the plurality of information elements and the second subcollection comprising a second number of information elements of the plurality of information elements, the data processing system comprising:
(a) means for determining a first similarity between the first subcollection and the second subcollection;
(b) means for determining first coordinates for the first subcollection and the second subcollection in accordance with the first similarity;
(c) means for allocating a first area having first boundaries to the collection such that a first size of the first area is related to a number of information elements of the information;
(d) means for allocating a second area having second boundaries to the first subcollection such that a second size of the second area is related to the first number;
(e) means for allocating a third area to the second subcollection such that a third size of the third area is related to the second number;
(f) means for positioning the second and third areas within the first boundaries of the first area in accordance with the first coordinates;
(g) means for determining a second similarity between a first information element of the first number of information elements and a second information element of the first number of information elements; and
(h) means for positioning the first information element and the second information element within the second boundaries in accordance with the second similarity.

30. The data processing system according to claim 29, wherein the means for determining the first similarity between the first subcollection and the second subcollection further comprises:
means for calculating a first centroid for the first subcollection and calculating a second centroid for the second subcollection; and
means for determining the first similarity between the first subcollection and the second subcollection by calculating a third similarity between the first centroid and the second centroid.

31. The data processing system according to claim 30, wherein the first and second centroids are respective geometrical centers of gravity of the second and third areas.

32. The data processing system according to claim 30, wherein the means for positioning the second and third areas within the first boundaries of the first area in accordance with the first coordinates further comprises:
means for determining a center of the first area;
means for determining which weight of the first and second weights is a smaller weight; and
means for arranging a centroid of the first and second centroids having the smaller weight closer to the center than the remaining centroid of the first and second centroids.

33. The data processing system according to claim 30, wherein the second boundary is located between the second area and the third area and is determined by a perpendicular bisector b(p, pᵢ) which is perpendicular to a straight line (\overline{ppᵢ}) between the first centroid and the second centroid, with p being first coordinates of the first centroid, pᵢ being second coordinates of the second centroid.

34. The data processing system according to claim 33, wherein a second distance between the first centroid and a point of intersection of the perpendicular bisector b(p, pᵢ) and the straight line (\overline{ppᵢ}) is calculated by means of the following equation:
d_{pw}(p, pᵢ; wᵢ)=∥\vec{p}−\vec{p}ᵢ∥²−fwᵢ;
with d_{pw}(p, pᵢ; wᵢ) being the second distance which is additively weighted, with p being the first coordinates of the first centroid, pᵢ being the second coordinates of the second centroid and wᵢ being the second weight and f being a scale factor.

35. The data processing system according to claim 34, wherein the means for positioning the second and third areas within the first boundaries of the first area in accordance with the first coordinates further comprises
means for determining a center of the first area;
means for determining which weight of the first and second weights is a smaller weight; and
means for arranging a centroid of the first and second centroids having the smaller weight closer to the center than the remaining centroid of the first and second centroids.

36. The data processing system according to claim 34, wherein the scale factor f is a global scale factor to ensure that the perpendicular bisector b(p, pᵢ) is between the first centroid and the second centroid.

37. The data processing system according to claim 30, wherein the first centroid is given a first weight and the second centroid is given a second weight, wherein the first weight corresponds to the first number and the second weight corresponds to the second number.

38. The data processing system according to claim 37, wherein the second boundary is located between the second area and the third area and is determined by a perpendicular bisector b(p, pᵢ) which is perpendicular to a straight line (\overline{ppᵢ}) between the first centroid and the second centroid, with p being first coordinates of the first centroid, pᵢ being second coordinates of the second centroid.

39. The data processing system according to claim 30, further comprising means for calculating the first coordinates on the display for the first and second centroids by using a first force between the first and second centroids.

40. The data processing system according to claim 39, wherein the means for determining the first coordinates for the first subcollection and the second subcollection further comprises:
means for generating second coordinates on the display for the first and second centroids at random;
means for determining a second force which is attractive and which is proportional to the third similarity;
means for determining a third force which is inversely proportional to a first distance between the first and second centroids on the basis of the second coordinates; and
means for determining a fourth gravitational force; and wherein the first force comprises the second, third and fourth forces.

41. A data processing system according to claim 39, wherein the first force is calculated in accordance with the following equation:
$$force ( {D}_{i} , {D}_{j} ) = {sim ( {D}_{i} , {D}_{j} )}^{d} - \frac{w}{dist ( {D}_{i} , {D}_{j} )} + grav$$
wherein force(Dᵢ, Dⱼ) is the first force, sim(Dᵢ, Dⱼ)^{d} is the second force,
$$\frac{w}{dist ( {D}_{i} , {D}_{j} )}$$
is the third force with w being proportional to at least one element of the group consisting of the first and second number, dist(Dᵢ, Dⱼ) is the first distance and grav is the fourth force and wherein Dᵢ is the first centroid and Dⱼ is the second centroid and d is a discriminator, with d>=1.

42. The data processing system according to claim 30, wherein the third similarity is calculated in accordance with the following equation:
$$sim ( {D}_{i} , {D}_{j} ) = \frac{{\sum }_{k = 1}^{L} ( {x}_{i , k} {x}_{j , k} )}{\sqrt{{\sum }_{k = 1}^{L} {x}_{i , k}^{2} {\sum }_{k = 1}^{L} {x}_{j , k}^{2}}}$$
with sim(Dᵢ, Dⱼ) being the third similarity, Dᵢ being the first centroid and Dⱼ being the second centroid, L being a dimensionality and x_{i,q} being a q'th component of a term vector representing the first centroid.

43. The data processing system according to claim 42, further comprising means for calculating the first coordinates on the display for the first and second centroids by using a first force between the first and second centroids.

44. The data processing system according to claim 29, wherein the first coordinates are determined in accordance with the following equation:
$${D}_{i} \cdot x = \frac{1}{N - 1} {\sum }_{j = 1 , j \neq i}^{N} force ( {D}_{i} , {D}_{j} ) * {D}_{j} \cdot x + ( 1 - force ( {D}_{i} , {D}_{j} ) ) * {D}_{i} \cdot x$$
wherein D_{i.}x is an x-coordinate of the first coordinates, force(Dᵢ, Dⱼ) is the first force, wherein N is a total amount of information elements of the information.

45. The data processing system according to claim 29, wherein the second similarity is calculated in accordance with the following equation:
$$sim ( {E}_{u} , {E}_{v} ) = \frac{{\sum }_{l = 1}^{L} ( {y}_{u , l} {y}_{v , l} )}{\sqrt{{\sum }_{l = 1}^{L} {y}_{u , l}^{2} {\sum }_{l = 1}^{L} {y}_{v , l}^{2}}}$$
with sim(Eᵤ, Eᵥ) being the second similarity, Eᵤ being the first information element and Eᵥ being the second information element, L being a dimensionality and y_{u,q} being a q'th component of a term vector representing the first information element.

46. The data processing system according to claim 29, wherein the means for calculating a second similarity between a first information element of the first number of information elements and a second information element of the first number of information elements further comprises means for calculating the third coordinates on the display for the first and second information elements by using a fifth force between the first and second information elements.

47. The data processing system according to claim 46, wherein the fifth force is calculated in accordance with the following equation:
$${E}_{u} \cdot x = \frac{1}{N - 1} {\sum }_{v = 1 , v \neq u}^{N} force ( {E}_{u} , {E}_{v} ) * {E}_{v} \cdot x + ( 1 - force ( {E}_{u} , {E}_{v} ) ) * {E}_{v} \cdot x$$
wherein E_{u.x} is an x-coordinate of the fourth coordinates, force(Eᵤ, Eᵥ) is the fifth force.

48. The data processing system according to claim 46, wherein the means for calculating the second similarity between the first information element of the first number of information elements and the second information element of the first number of information elements further comprises:
means for generating fourth coordinates on the display for the first and second information elements at random;
means for determining a sixth force which is attractive and which is proportional to the second similarity;
means determining a seventh force which is inversely proportional to a third distance between the first and second information elements on the basis of the fourth coordinates; and
means for determining an eighth gravitational force; and
wherein the fifth force comprises the sixth, seventh and eighth forces.

49. The data processing system according to claim 48, wherein the fourth coordinates are determined in accordance with the following equation:
ty=ty+force(Eᵤ, Eᵥ)*Eᵤ.y+(1−force(Eᵤ, Eᵥ))*Eᵤ.y
wherein E_{u.y} is an x-coordinate of the fourth coordinates, force(Eᵤ, Eᵥ) is the fifth force and Eᵤ's new x-coordinate is Eᵤ.Y=ty/T, with T being a dimensionality.

50. The data processing system according to claim 48, wherein the fifth force is calculated in accordance with the following equation:
$${E}_{u} \cdot x = \frac{1}{N - 1} {\sum }_{v = 1 , v \neq u}^{N} force ( {E}_{u} , {E}_{v} ) * {E}_{v} \cdot x + ( 1 - force ( {E}_{u} , {E}_{v} ) ) * {E}_{v} \cdot x$$
wherein E_{u.x} is an x-coordinate of the fourth coordinates, force(Eᵤ, Eᵥ) is the fifth force.

51. The data processing system according to claim 50, wherein the fourth coordinates are determined in accordance with the following equation:
ty=ty+force(Eᵤ, Eᵥ)*Eᵤ.y+(1−force(Eᵤ, Eᵥ))*Eᵤ.y
wherein E_{u.y} is an x-coordinate of the fourth coordinates, force(Eᵤ, Eᵥ) is the fifth force and Eᵤ's new x-coordinate is Eᵤ.Y=ty/T, with T being a dimensionality.

52. The data processing system according to claim 29, further comprising means for controlling the display for displaying the information such that an image displayed on the display resembles an area of a night sky as seen trough a telescope or as seen by a naked eye, wherein each information element of the first and second number of information elements is represented as a graphic sign.

53. The data processing system according to claim 29, wherein the information elements are selected from a group consisting at least of documents, subcollections and collections.

54. The data processing system according to claim 29, wherein the data processing system is a client-server system.

55. A computer program product stored on a computer usable medium, comprising:
(a) computer readable program means for causing a computer to display information on a display, the information being organized in a collection comprising a first subcollection and a second subcollection, the first subcollection comprising a first number of information elements of the plurality of information elements and the second subcollection comprising a second number of information elements of the plurality of information elements;
(b) computer readable program means for causing the computer to determine a first similarity between the first subcollection and the second subcollection;
(c) computer readable program means for causing the computer to determine first coordinates for the first subcollection and the second subcollection on the basis of the first similarity;
(d) computer readable program means for causing the computer to allocate a first area having first boundaries to the collection such that a first size of the first area is related to a number of information elements of the information;
(e) computer readable program means for causing the computer to allocate a second area having second boundaries to the first subcollection such that a second size of the second area is related to the first number;
(f) computer readable program means for causing the computer to allocate a third area to the second subcollection such that a third size of the third area is related to the second number;
(g) computer readable program means for causing the computer to position the second and third areas within the first boundaries of the first area on the basis of the first coordinates;
(h) computer readable program means for causing the computer to calculate a second similarity between a first information element of the first number of information elements and a second information element of the first number of information elements; and
(i) computer readable program means for causing the computer to position the first information element and the second information element within the second boundaries in accordance with the second similarity.

56. A computer program adapted to be loaded into an internal memory of a computer, comprising software code portions for performing the steps:
displaying information comprising a plurality of information elements on a display, the information being organized in a collection comprising a first subcollection and a second subcollection, the first subcollection comprising a first number of information elements of the plurality of information elements and the second subcollection comprising a second number of information elements of the plurality of information elements;
determining a first similarity between the first subcollection and the second subcollection;
determining first coordinates for the first subcollection and the second subcollection in accordance with the first similarity;
allocating a first area having first boundaries to the collection such that a first size of the first area is related to a number of information elements of the information;
allocating a second area having second boundaries to the first subcollection such that a second size of the second area is related to the first number;
allocating a third area to the second subcollection such that a third size of the third area is related to the second number;
positioning the second and third areas within the first boundaries of the first area in accordance with the first coordinates;
determining a second similarity between a first information element of the first number of information elements and a second information element of the first number of information elements; and
positioning the first information element and the second information element within the second boundaries in accordance with the second similarity.
